(19) United States
(12) Patent Application Publication
(10) Pub. No.: US 2003/0006292 A1
(43) Pub. Date: Jan. 9, 2003

(54) Device for assuring proper application of coatings

(76) Inventor: Kevin Kornprobst, Somerset, PA (US)

Correspondence Address: BUCHANAN INGERSOLL, P.C., ONE OXFORD CENTRE, 301 GRANT STREET, 20TH FLOOR, PITTSBURGH, PA, 15219, US

(21) Appl. No.: 09/997,387

(22) Filed: Nov. 29, 2001

Related U.S. Application Data
(60) Provisional application No. 60/303,832, filed on Jul. 9, 2001.

(51) Int. Cl. B05B 17/04

(52) U.S. Cl. 239/13; 239/135; 239/139; 239/75; 239/67; 239/71

(57) ABSTRACT

An apparatus and method for heating spray equipment hoses used during inclement weather can heat water, or other medium, to a desired temperature, circulate the heated water in thermal contact with, but separated from, the spray equipment hoses to heat the material therein and generally maintain the material at an appropriate temperature to facilitate spraying.

### RELATED APPLICATION

This application is based on U.S. Provisional Patent Application Serial No. 60/303,832, filed Jul. 9, 2001.

### BACKGROUND

This invention relates generally to spray equipment for applying coatings such as insulating foams and polymeric rust-proofing coatings, and more particularly to an apparatus for heating spray equipment hoses when applying such coatings in inclement weather, especially cold weather.

Commercial contractors have difficulty applying coatings such as insulating foams and polymeric rust-proofing coatings during inclement weather conditions. To address this problem, manufacturers of spray equipment presently make electrically heated hoses for use in inclement weather conditions. However, not only are the electrically heated hoses expensive, they are subject to damage due to fraying, which leads to high maintenance costs, and can also present serious fire and electrical shock hazards.

Accordingly, there is a need for spray equipment which can maintain the spray material at a desired temperature, or range thereof, for use in inclement weather, but without the hazards that can be associated with electrically heated hoses.

### SUMMARY

The invention provides an apparatus and method for heating spray equipment hoses when the spray equipment is used in inclement weather, and particularly in cold weather. The invention can not only provide a more uniform heating of the material being applied, it can also significantly reduce operating costs and maintenance requirements, and can eliminate fire and electrical shock hazards associated with conventionally used equipment. A presently preferred embodiment of the invention can comprise an apparatus and method for heating water to a desired temperature, circulating the heated water in thermal contact with, but separated from, the material to be sprayed in order to provide the necessary heating of the sprayed material. The water can be heated and circulated through a first hose which is positioned adjacent a second hose through which the spray material is circulated. Both the first and second hoses can be surrounded by an outer sheath which hold both hoses firmly adjacent to each other so that the heating medium circulated through the first hose heats the spray material in the second hose. Alternatively, for example, the second hose through which the spray coating medium is circulated could be of a smaller diameter and could be disposed within a larger diameter second hose through which the heated medium is circulated. Other alternative arrangements may similarly be devised by applying the general teaching in this specification. Moreover, although the medium is preferably water, it is to be understood that other mediums could also be satisfactorily employed, including, for example, a water-glycol mixture.

The entire apparatus can include a storage container for storing a supply of water or other heating medium, associated equipment such as a pump, thermostat, pressure and temperature sensors or gauges for providing feedback to a processor, or a human operator, for use in controlling the apparatus. The apparatus can also include water supply line and return lines, a heating device for controlling the temperature of the heating medium in the storage container, such as a heater band or heating elements, and an expansion tank associated with the storage container. Various valves can also be provided where needed or desired for control purposes such as are common in pressurized systems.

Other details, objects, and advantages of the invention will become apparent from the following detailed description and the accompanying drawings figures of certain embodiments thereof.

### BRIEF DESCRIPTION OF THE DRAWING FIGURES

A more complete understanding of the invention can be obtained by considering the following detailed description in conjunction with the accompanying drawings, in which:

FIG. 1 illustrates a prior art apparatus for heating a spray medium in an outer sheath for use in inclement weather.

FIG. 2 is a simplified schematic illustrating a presently preferred embodiment of the invention.

FIG. 3 is a cross-section view of a presently preferred embodiment of the paint hose and heating lines enclosed in a sheath.

FIG. 4 is perspective view, partially in section, illustrating an embodiment of the disposition of the supply, return, and spray coating lines at the end of the sheath where the paint hoses exit the sheath.

FIG. 5 is a view similar to FIG. 4 showing an alternative embodiment.

FIG. 6 is a simplified schematic illustrating a presently preferred alternative embodiment of the invention.

### DETAILED DESCRIPTION OF CERTAIN EMBODIMENTS

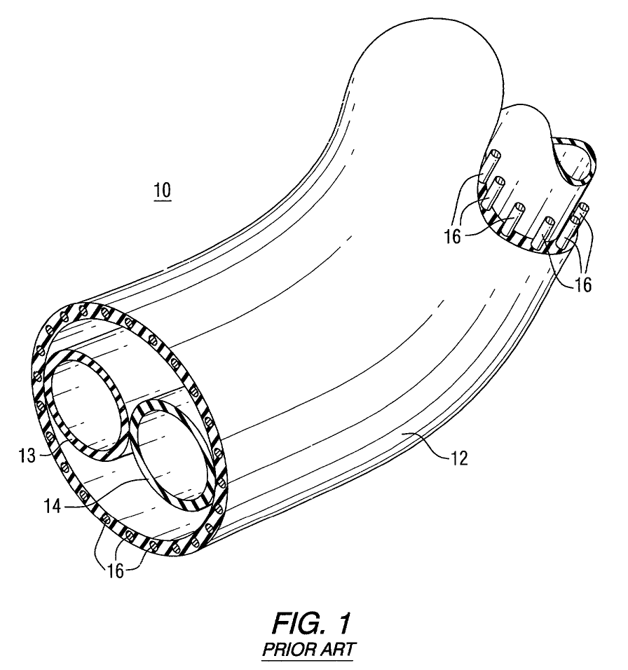

To aid in understanding the presently preferred embodiments of the invention, it may be helpful to first describe a prior art type hose heating apparatus 10, as shown in FIG. 1. The hose heating apparatus 10 is essentially an electrically heated outer sheath 12 which surrounds one or more paint hoses 13,14 which are to be heated. The outer sheath 12 has electrical conductors 16 incorporated into the outer sheathing 12 through which electricity can flow in order to generate heat to warm the ensheathed paint hose 13,14. The conductors 16 can be resistive metal, for example copper, such that heat is generated when electricity is applied. Although the conductors 16 are shown generally axially embedded in the sheath, they could be disposed in other configurations, such as coils would circumferentially through sheath 12. As described previously, a problem with this apparatus 10 can be that over time, especially since the sheath 12 is frequently dragged around over the ground, the sheath 12 can wear, break or crack, thus exposing the conductors 16. This has been known to occur and cause fires. The paint flowing through the paint hose 14 is typically highly flammable, and can be ignited by sparking or burning caused by exposed conductors 16, causing a fire. Clearly, this can create a hazardous condition for workers, even more so because the paint is also commonly under high pressure, such as about 1000-3000 psi. If one of the paint hoses 13,14 bums through, it can become like a torch, or even cause an explosion.

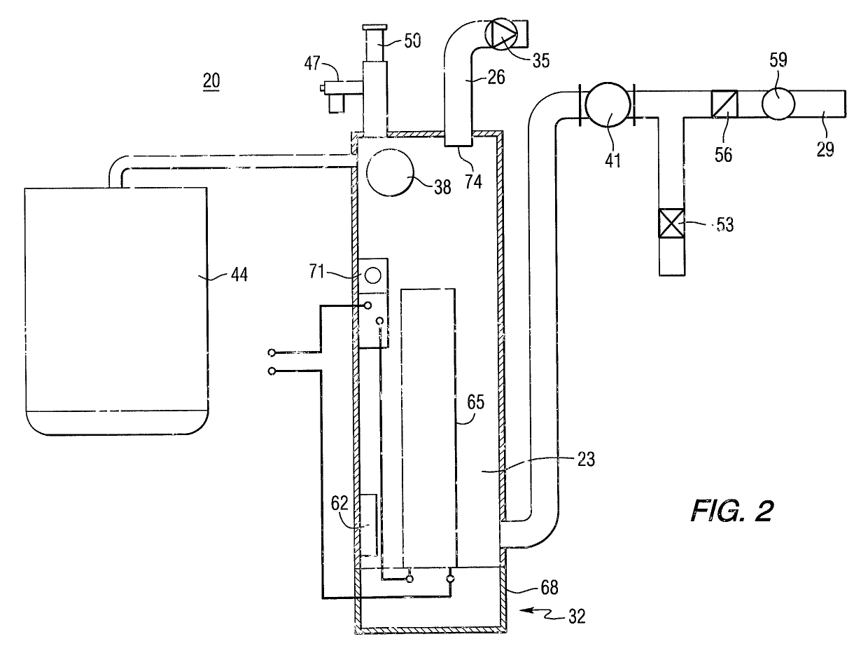

A presently preferred embodiment of an apparatus 20 for heating paint, or other spray medium, circulated through one or more hoses is shown in FIG. 2, generally comprising a water storage container 23 with connections to supply 26 and return 29 lines. The supply 26 and return 29 lines can be conventional hose of a durability and diameter suited to the particular application. In a preferred embodiment, 5/16 diameter hose is utilized for the supply 26 and return 29 lines. A heating device 32 heats water, or other medium, such as a water glycol mixture, stored in the container 23 which is circulated by a pump 35 through the supply 26 and return 29 lines. Basically, hot water from the storage container 23 is circulated by the pump 35 through the supply 26 and return 29 lines. The heated water returns to the storage container 23 through the return line 29 where it is then re-heated in the storage container 23 and re-circulated through the supply line 26 in a continuous cycle.

Other presently preferred components can include temperature and pressure sensor 38, associated with the storage container 23 and a temperature sensor 41 associated with the return line 29. A conventional “two-in-one” type combination temperature and pressure sensor 38 can be used at the storage container 23. An expansion tank 44, relief valve 47 and air vent 50 can also be utilized in connection with the storage container 23 for purposes as are common in heated, pressurized circulation systems such as the apparatus 20. Additionally, various valves can be utilized, including an auto-fill valve 53, a ball valve 56 and a purge valve 59, for controlling various functions of the apparatus 20. The auto-fill valve 53 feeds water into the storage container 23 automatically to maintain a certain level of water, in the event of a break in the return hose 29, or any other condition which would cause the water in the storage container 23 to be depleted. Thus, like a boiler in a household hot water heater, the auto-fill valve 53 maintains a certain level of water in the storage container 23 in so that no undesirable conditions develop. A low water cut off sensor/valve 62 can be purchased for about one hundred dollars, and though relatively large, could be made to fit in the storage container 23. The low water cut off sensor can be used as a safety measure to shut of the heating device 32, or thermostat 71, in the event of a malfunction of the auto fill valve 53, or break in the supply line to the auto fill valve 53, which would make it impossible for the auto fill valve 53 to maintain a minimum water level in the container 23.

In a presently preferred embodiment, the storage container 23 can be square, and constructed out of 4×4 tube with top and bottom covers welded on. Preferably, as made more convenient by constructing the storage container 23 from square stock, the entire apparatus 20 can be designed entirely for containment in a relatively portable cabinet. The heating device 32 can be a screw-in heating element is positioned inside the storage container, similar to as used in conventional home water heater units. Such a heating element 32 can, for example, be about 1500 W and can utilize a 120 V or 220 V power source. The heating element 32 threads up through the bottom cover of the storage container 23 about an one or one and one-half inch from the bottom. Of course, The resistive heating elements 65 extend further up inside the storage container 23. The attachment portion 68 of the heating element 32 simply threads into the bottom cover just as in a common water heater, thus making the apparatus 20 less inexpensive and more easily produced. A temperature control device 71, for example, a conventional thermostat, can be used in conjunction with the heating element 32 just as in common household water heaters.

The return line 29 connects through the side of the storage container 23 near the bottom and the hot water supply line 26 connects through the top cover. The circulation pump 35 can be a Tako™ brand circulation pump used on the supply line 26 to circulate the heated water through the system. The relief valve 47 can also be connected through the top of the storage container 23 and the air vent 50 can be provided communicating with the same connection that the relief valve 47 is associated with coming out of the top of the storage container 23. A connection through the side of the storage container near the top cover communicates with an expansion tank 44. The low water cut-off valve 62, such as is sometimes used on household water heaters, can be provided to turn off the heating element 32 if the water level were to fall below a predetermined level.

In pressurized systems such as this, there will commonly be some air in the lines at times, which is one reason why the purge valve 59 is provided. When water is supplied into the storage container 23, that water pushes out water already in the storage container 23. Then, like a garden hose, this water is eventually pushed, e.g., circulated by the pump 35, through the supply line 26 and back into the storage container 23 via the return line 29. The supply line 26 extends down into the storage container 23 slightly. The purpose being that if any air comes from the return line 29 into the storage container 23, that air will rise to the top of the storage container 23, which provides a separation area above the bottom of the supply line inlet 74 where the air can be vented out automatically, via the air vent 50. This works well so long as the water level is maintained higher than the supply line inlet 74, which level is maintained by the auto-fill valve 53. The auto-fill valve 53 thus maintains the level of water in the storage container 23 so that any trapped air in the system is escapes out the air vent 50 automatically. The air vent 50 does not vent pressure because it has an internal float. The float is normally in the dropped down position, which permits any trapped air to escape out the air vent 50. However, if the water level rises to the point where it contacts the float, the float rises, like in a toilet, and closes off the air vent 50. This condition can be why the relief valve 47 is provided. When and if the pressure builds up when/if the float closes off the air vent 50, the relief valve 47 will vent any excess pressure build-up that may occur in the storage container 23. Such a pressure build-up could occur if the expansion tank 44, or the bladder in the expansion tank 44, would rupture, or some other condition would occur causing a pressure build up in the storage container 23.

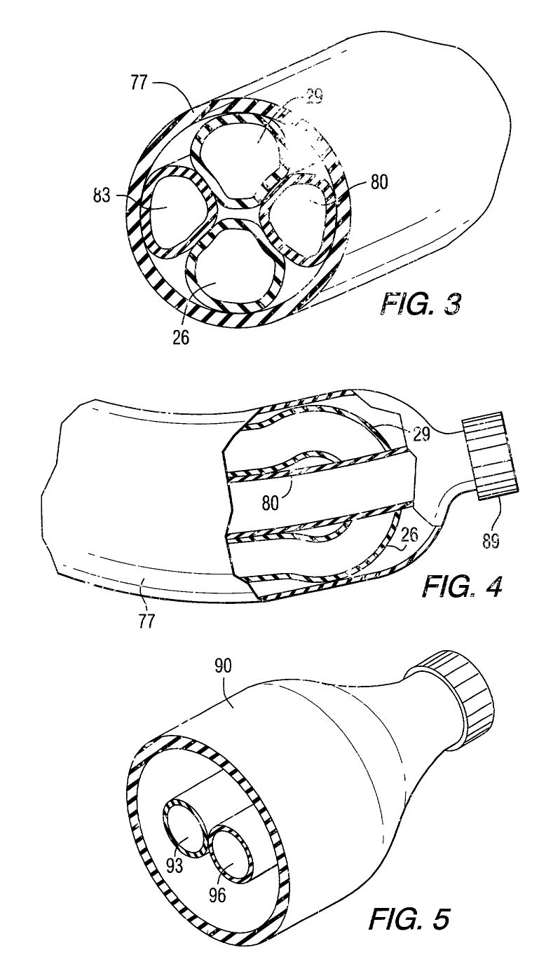

Referring now to FIGS. 3 and 4, the supply 26 and return 29 lines, and the paint hose, can all be enclosed in an outer sheath 77 which holds the supply 26 and return 29 lines against one or ore paint hoses 80,83 such that paint being circulated through the paint hoses 80,83 is heated by conductive heat transfer through the walls of the supply 26 and return 29 lines and the walls of the paint hoses 80,83. There are also typically two paint hoses 80, 83 for the paint. The paint is preferably maintained at a temperature of 120 degrees, and as much as 180 degrees. The paint itself makes heat when it's first used. In fact, the paint itself is generally so hot that it does not require heating while the paint is flowing through the paint hoses 80,83. However, heating becomes important if/when painting is paused for various reasons, in order to keep the paint in the paint from cooling off. The paint can cool substantially when painting is paused if the hoses 80, 83 is not heated, particularly in cold weather. Thus, the main function of the heated supply 26 and return 29 lines is to generally maintain the paint in the paint hoses 80,83 within a desired range of temperatures. The supply 26 and return 29 lines, and the paint hoses 80,83 can all be positioned tightly together, enclosed in, the sheath 77, which can also be insulated to further retain heat. The sheath 77 can be obtained from ______ Company, located in Monroeville, Pa. Essentially, the two paint hoses 80,83 and the supply 26 and return 29 lines are placed adjacent each other and surrounded by the outer sheath 77. Thus, there will commonly be four lines enclosed in the sheath 77.

Referring particularly to FIG. 4, in the simplest form, the supply 26 and return 29 lines can be the same continuous hose which simply is bent in a “U” the end of the sheath, at which point the both paint hoses 80 and 83 (not shown) can merge at a single opening through the sheath 77, such as via connector 89 for attachment to a spray gun applicator (not shown). Alternatively, as shown in FIG. 5, a supply and/or return line 90 could be a larger diameter hose and one or more smaller diameter paint hoses 93,96 could actually be enclosed within the supply line 90 and heated by the heated water circulated within the supply line around the paint hoses 93,96.

The temperature sensor 41 on the return line 29 can be used to provide feedback for maintaining the return line 29 water temperature at, for example, 120 degrees, which can be the usual temperature desired for the return line 29 water for a typical type of paint used. This feedback could be used to control the heating element 29 to maintain the water temperature in the storage container 23 at a sufficiently high temperature to ensure that the return line 29 water temperature is at the minimum desired temperature, for example, 120 degrees F. The feedback can be used, for example, as input to the thermostat 71 to control the temperature of the water in the storage container 23. By way of example, the initial thermostat 71 setting would be adjusted if the return water temperature were detected at a temperature cooler than the desired temperature.

In a presently preferred embodiment, the storage container 23 can be 4×4 inches square and about 14-20 inches high. The air vent 50 can be about 2-4 inches high and all of the connections for the lines and valves to the storage container 23 can preferably be welded. The heating element 32, the temperature/pressure sensors 38,41 the thermostat 71, expansion tank 44, and other similar types of components are conventional and can all be purchased from retailers of such items. An expansion tank 44 commonly known as a “brad-air tank,” which has an inner bladder, is preferably used. Typically, there can be about 12-15 psi in the expansion tank 44, with the relief valve 47 set to reduce pressure if about 30 psi builds up. Typically, about 12 psi pressure is the norm through the entire system and the water is heated typically to about 160 degrees F in the storage container 23.

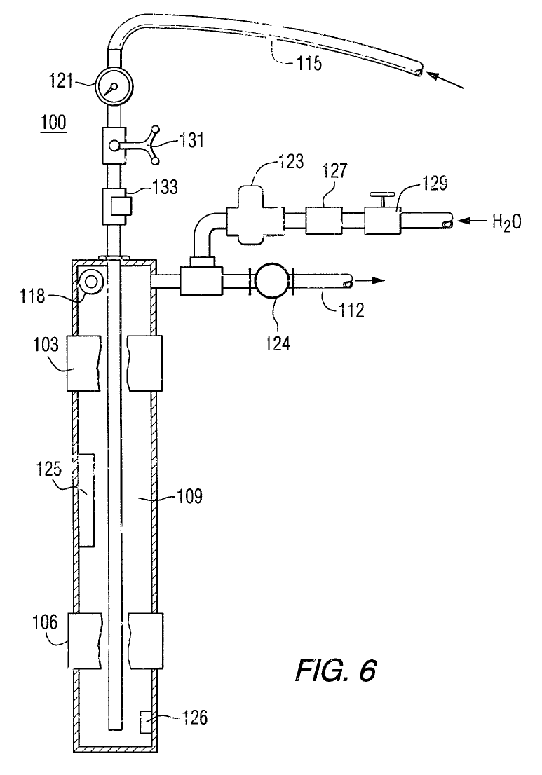

An alternative embodiment of a paint hose heating apparatus 100 is shown in FIG. 6, which can include much of the same components as the apparatus 20 shown in FIG. 2, with some minor differences. Some differences can include, for example, band heaters 103, 106 which can be strapped around the storage container 109 for heating the water, or other heating medium, instead of a heating element 32. Preferably, two band heaters 103, 106 can be used, each being about 600 W and using a 220 V power source, one positioned near the upper and lower ends of the storage container 109. Additionally, the storage container 109 can be cylindrical and made out of 2 ½ inch steel pipe with covers welded on both the top and bottom ends. The various connections to the storage container 109 can also be slightly different. For example, in this embodiment, the supply line 112 connects through the side of the storage container 109 near the top end, and the connection for the return line 115 extends down through the top cover almost to the bottom of the storage container 109. In this way cooler water is returned to the bottom of the storage container 109 and the heated/hot water is maintained near the top of the storage container 109 at the level of the supply line 112. However, similarly to the apparatus 20 shown in FIG. 2, temperature and/or pressure sensors can be provided for obtaining the same type of information for the same purposes explained previously. These can include a combination temperature and pressure sensor 118 associated with the storage container 109 and a temperature sensor 121 on the return line 115. Other like components can include an auto fill valve 123, circulation pump 124, thermostat 125, low water cut off valve/sensor 126, and various valves, such as ball valve 127, and purge valves 129, 131. A pressure relief valve 133 can also be provided. Moreover, although not shown, an expansion tank, such as the expansion tank 44 shown in FIG. 2, can also be used with the alternative apparatus 100.

Although certain embodiments of the invention have been described in detail, it will be appreciated by those skilled in the art that various modifications to those details could be developed in light of the overall teaching of the disclosure. Accordingly, the particular embodiments disclosed herein are intended to be illustrative only and not limiting to the scope of the invention which should be awarded the full breadth of the following claims and any and all embodiments thereof.

What is claimed is:

1. An apparatus for heating spray equipment hoses comprising:
a. at least one hose associated with said spray equipment through which a spray material is caused to flow for application by said spray equipment;
b. a heating medium source;
c. a supply line in communication with said source, said heating medium circulated through said supply line from said source;
d. a return line communicating with said supply line and said source, said heating medium circulated back to said source through said return line; and
e. an outer sheath surrounding said at least one hose and said supply and return lines such that said supply and return lines are secured adjacent said at least one hose and said heating medium circulating through said supply and return lines heats said at least one hose and said spray material flowed therethrough.

2. The apparatus of claim 1 wherein said source further comprises:
a. a storage container;
b. a heating device associated with said storage container for heating said heating medium in said storage container.

3. The apparatus of claim 2 further comprising:
a. a first temperature sensor sensing the temperature of said heating medium in said storage container; and
b. a temperature control device associated with said heating device and receiving feedback from said first temperature sensor to generally maintain said first temperature at a desired temperature.

3. The apparatus of claim 3 further comprising:
a. a second temperature sensor sensing the temperature of said heating medium in said return line; and
b. said temperature control receiving feedback from said second temperature sensor to generally maintain said first temperature at a level necessary to generally maintain said second temperature at a desired temperature.

4. The apparatus of claim 3 further comprising a processor receiving feedback from at least one of said first and second temperature sensors, said processor associated with at least one of said temperature control device and said heating device for regulating the temperature of said heating medium in said storage container.

5. The apparatus of claim 2 further comprising an auto fill valve connected between said storage container and an external supply of heating medium, said auto-fill valve maintaining a predetermined amount of heating medium in said storage container.

6. The apparatus of claim 5 further comprising a low water level cut off sensor providing feedback corresponding to the water level in said container, said heating device discontinuing said heating responsive to feedback indicative of a water level below a predetermined level.

7. The apparatus of claim 3 further comprising at least one of:
a. an expansion tank associated with said storage container;
b. a pressure relief valve associated with said storage container;
c. an air vent associated with said storage container; and
d. a purge valve associated with said return line;

8. A method of heating spray equipment hoses comprising:
a. flowing spray material through a first hose;
b. flowing a heating medium through a second hose; and
c. securing said first and second hoses adjacent each other such that said heating medium in said second hose heats said spray material in said first hose.

9. The method of claim 8 further comprising:
a. storing said heating medium in a container, said second hose in communication with said container; and
b. heating said heating medium in said container.

10. The method of claim 9 further comprising:
a. sensing a first temperature of said heating medium in said container; and
b. regulating said first temperature to generally maintain a desired temperature via feedback from sensing said first temperature.

11. The method of claim 10 further comprising:
a. flowing said heating medium from said second hose through a third hose, said third hose in communication with said container such that said heating medium is circulated from said container through said second hose and returned to said container through said third hose;
b. sensing a second temperature of said heating medium in said second hose; and
c. regulating said first temperature to generally maintain said first temperature at a level necessary to generally maintain said second temperature at a desired temperature using feedback from sensing said second temperature.

12. The method of claim 9 further comprising maintaining a minimum level of heating medium in said container.

13. The method of claim 9 further comprising:
a. sensing a level of heating medium in said container; and
b. discontinuing heating said heating medium responsive to sensing a level of heating medium in said container below a predetermined minimum level.

14. The method of claim 9 further comprising at least one of:
a. accommodating expansion of said heating medium in said container;
b. relieving excess pressure from said container;
c. venting trapped air from said container; and
d. purging air from said third hose.
